(19) United States
(12) Patent Application Publication
(10) Pub. No.: US 2025/0372991 A1
(43) Pub. Date: Dec. 4, 2025

(54) Seal Assembly

(71) Applicant: TE Connectivity Solutions GmbH, Schaffhausen (CH)

(72) Inventor: Christopher Ryan Raybold, Middletown, PA (US)

(73) Assignee: TE Connectivity Solutions GmbH, Schaffhausen (CH)

(21) Appl. No.: 18/676,983

(22) Filed: May 29, 2024

(51) Int. Cl. H02G 15/013; F16J 15/02

(52) U.S. Cl. CPC H02G 15/013; F16J 15/027

(57) ABSTRACT

A seal assembly includes a seal and an adhesive positioned in the seal. The seal has a first section and a second section extending from the first section. The seal has a sealing passageway extending through the first section and the second section along a longitudinal direction. The second section has an adhesive channel extending around the sealing passageway. The adhesive is positioned in the adhesive channel of the second section. The adhesive is disposed on an inner surface of the seal in the second section.

### FIELD OF THE INVENTION

The present invention relates to a seal assembly and, more particularly, to a seal assembly for sealing a cable.

### BACKGROUND

A seal is commonly an elastomeric material that is positioned between elements, such as a cable and a housing, to seal the elements with respect to each other. The seal is often placed around the cable and must form a reliable seal to the outer surface of the cable. In some applications, for example when the cable is a flat flexible cable or another flat element, it is difficult to maintain a proper sealing pressure between the seal and the cable at the edges of the seal. The cable, in the case of a flat flexible cable, also has weak column strength and may be difficult to insert into the seal. Additionally, sharp edges of the flat cable can cut or otherwise damage the seal. The assembly of a non-round cable with available seals can thus lead to issues that impair the reliability of the seal over time.

### SUMMARY

A seal assembly includes a seal and an adhesive positioned in the seal. The seal has a first section and a second section extending from the first section. The seal has a sealing passageway extending through the first section and the second section along a longitudinal direction. The second section has an adhesive channel extending around the sealing passageway. The adhesive is positioned in the adhesive channel of the second section. The adhesive is disposed on an inner surface of the seal in the second section.

### BRIEF DESCRIPTION OF THE DRAWINGS

The invention will now be described by way of example with reference to the accompanying Figures, of which:

FIG. 1 is a perspective view of a sealed cable according to a first embodiment;

FIG. 2 is another perspective view of the sealed cable of FIG. 1;

FIG. 3 is a sectional side view of the sealed cable of FIG. 1, taken along line 3-3 in FIG. 1;

FIG. 4 is a sectional perspective view of the sealed cable of FIG. 1, taken along line 4-4 in FIG. 1;

FIG. 5 is a perspective view of a sealed cable according to a second embodiment;

FIG. 6 is another perspective view of the sealed cable of FIG. 5;

FIG. 7 is a sectional side view of the sealed cable of FIG. 5, taken along line 7-7 in FIG. 1;

FIG. 8 is a sectional perspective view of the sealed cable of FIG. 5, taken along line 8-8 in FIG. 1;

FIG. 9 is a perspective view of a sealed cable according to a third embodiment;

FIG. 10 is another perspective view of the sealed cable of FIG. 9;

FIG. 11 is a sectional side view of the sealed cable of FIG. 9, taken along line 11-11 in FIG. 9; and

FIG. 12 is a sectional perspective view of the sealed cable of FIG. 9, taken along line 12-12 in FIG. 9.

### DETAILED DESCRIPTION OF THE EMBODIMENT(S)

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art. In addition, in the following detailed description, for purposes of explanation, numerous specific details are set forth in order to provide a thorough understanding of the disclosed embodiments. However, it is apparent that one or more embodiments may also be implemented without these specific details.

Throughout the specification, directional descriptors are used such as “longitudinal”, “width”, and “height”. These descriptors are merely for clarity of the description and for differentiation of the various directions. These directional descriptors do not imply or require any particular orientation of the disclosed elements.

Throughout the drawings, only one of a plurality of identical elements may be labeled in a figure for clarity of the drawings, but the detailed description of the element herein applies equally to each of the identically appearing elements in the figure.

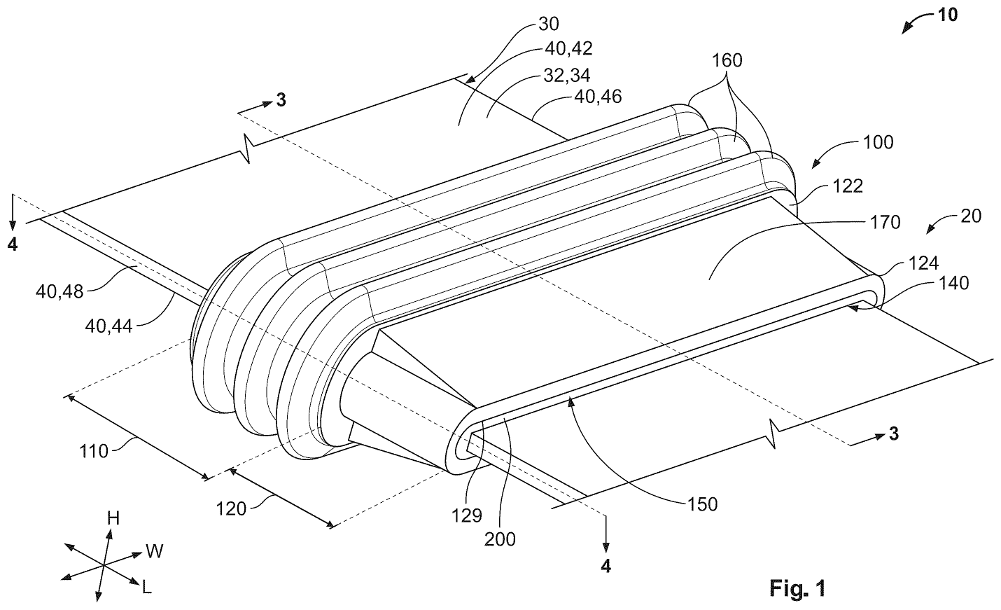

A sealed cable 10 according to an embodiment, as shown in FIGS. 1-4, includes a seal assembly 20 and a cable 30 positioned within the seal assembly 20. The seal assembly 20 includes a seal 100 and an adhesive 200 positioned within the seal 100. The adhesive 200 attaches the seal 100 to the cable 30.

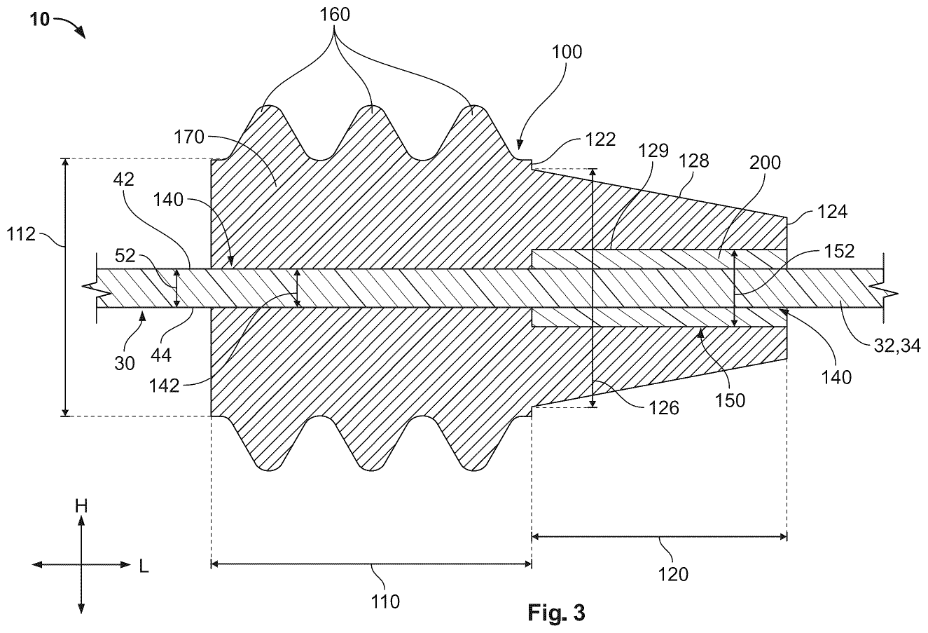

The seal 100 includes a first section 110 and a second section 120 extending from the first section 110 along a longitudinal direction L, as shown in FIGS. 1 and 3. The second section 120 extends from a first end 122 connected to the first section 110 to a second end 124 opposite the first end 122 along the longitudinal direction L.

In the embodiment shown in FIGS. 1-4, the first section 110 and the second section 120 are monolithically formed in a single piece from an elastomeric material 170, such as silicone or another elastomeric material compatible with high temperature processing.

As shown in FIGS. 1-4, the seal 100 has a plurality of ribs 160 that circumferentially surround the seal 100 and protrude outward from the seal 100 in the first section 110. The ribs 160 are formed of the elastomeric material and, in the shown embodiment, are monolithically formed in a single piece with the first section 110 and the second section 120. In the shown embodiment, the first section 110 has three ribs 160. In other embodiments, the first section 110 could have less than three or more than three ribs 160.

The first section 110, as shown in FIG. 3, has a first thickness 112 in a height direction H perpendicular to the longitudinal direction L. The second section 120, at an outer surface 128, tapers from the first end 122 to the second end 124. The second section 120 has a second thickness 126 in the height direction H at the start of the taper at the first end 122 of the second section 120. The first thickness 112 is greater than the second thickness 126.

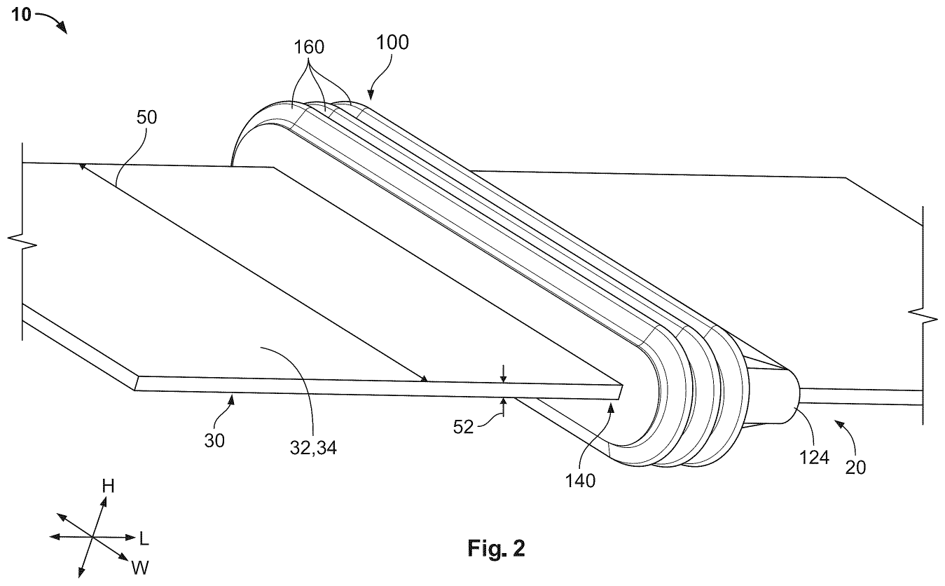

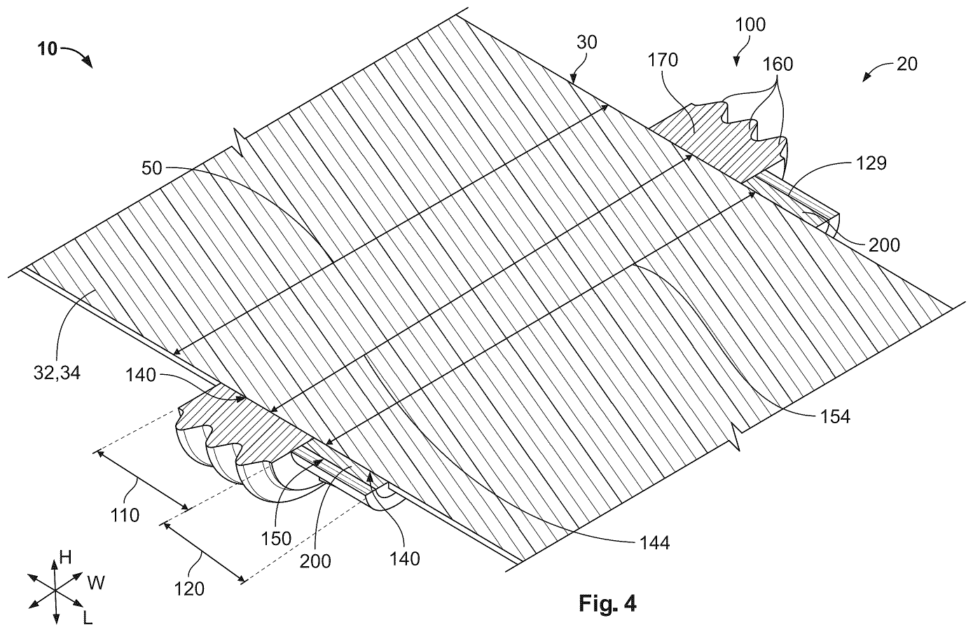

The seal 100 has a sealing passageway 140 extending through the first section 110 and the second section 120 along the longitudinal direction L, as shown in FIGS. 2-4. The scaling passageway 140 has a first height 142 in the height direction H, as shown in FIG. 3, and a first width 144 in a width direction W perpendicular to the longitudinal direction L and the height direction H, as shown in FIG. 4.

As shown in FIGS. 1, 3, and 4, the second section 120 has an adhesive channel 150 extending around the sealing passageway 140. The adhesive channel 150 has a second height 152 in the height direction H, as shown in FIG. 3, and a second width 154 in the width direction W, as shown in FIG. 4. The second height 152 is greater than the first height 142. The second width 154 is greater than the first width 144.

The adhesive 200, shown in FIGS. 1, 3, and 4, is positioned in the adhesive channel 150 around the sealing passageway 140. The adhesive 200 is disposed on an inner surface 129 of the second section 120 of the seal 100. In an embodiment, the adhesive 200 lines the inner surface 129 of the second section 120 by circumferentially covering an entirety of the inner surface 129. The adhesive 200 is a heat-activated adhesive; the adhesive 200 is in a solid state at room temperature and, when heated above a predetermined temperature, can reflow to attach a range of materials to one another. The adhesive 200 may be any type of heat-activated adhesive used, for example, in heat shrink tubing applications.

The cable 30 of the sealed cable 10 is positioned within the seal assembly 20 as shown in FIGS. 1-4. The cable 30 has a body 32 with a plurality of outer surfaces 40 including a top surface 42, a bottom surface 44 opposite the top surface 42 in the height direction H, a first side 46 extending between the top surface 42 and the bottom surface 44 along the height direction H, and a second side 48 opposite the first side 46. The cable 30 has a cable width 50 in the width direction W, as shown in FIGS. 2 and 4, and a cable height 52 in the height direction H, as shown in FIGS. 2 and 3.

In the shown embodiment, the cable 30 is a flat flexible cable and the body 32 is formed of an insulative material 34 with a plurality of cables embedded within the insulative material 34. In other embodiments, the cable 30 could be another type of insulative material with embedded cables, such as a flexible printed circuit or a ribbon cable, could be a flat, conductive element such as a bus bar, or could be any other non-round element that requires a seal.

The cable 30 is inserted into the seal assembly 20 to form the sealed cable 10 shown in FIGS. 1-4.

In an embodiment, the adhesive 200 in the solid state is first positioned within the adhesive channel 150 to be disposed on or line the inner surface 129 of the second section 120. The cable 30 is then inserted into the sealing passageway 140 to a position, shown in FIGS. 1, 3, and 4, in which the adhesive 200 contacts or abuts the outer surfaces 40 of the body 32. The adhesive 200 surrounds and contacts the top surface 42, the bottom surface 44, the first side 46, and the second side 48 of the body 32 of the cable 30. In the shown embodiment, the cable width 50 is approximately equal to the first width 144 of the sealing passageway 140 and the cable height 52 is approximately equal to the first height 142 of the sealing passageway 140 to form a tight fit between the seal 100 and the cable 30 in the first section 110. Throughout the present specification, the term “approximately equal” is intended to mean that two compared values are within 5% of each other.

The adhesive 200 is then activated by the application of heat, for example using heat conduction, radiation, or heat convection, to reflow the adhesive 200 and bond the body 32 of the cable 30 to the seal 100. A portion of the insulative material 34 of the body 32 of the cable 30 may also melt under the application of heat and form a part of the bond. The adhesive 200, when cooled and re-solidified, attaches the cable 30 to the seal 100. In this embodiment, the elastomeric material 170 has a melting temperature that is sufficiently high that the seal 100 does not melt under the application of heat that reflows the adhesive 200.

In other embodiments, instead of positioning the adhesive 200 in the adhesive channel 150 before insertion of the cable 30, the adhesive 200 in the solid state can be positioned on the body 32 of the cable 30 before the cable 30 is inserted into the sealing passageway 140. When the cable 30 is inserted into the sealing passageway 140, the adhesive 200 moves into the adhesive channel 150 of the second section 120 and is in contact with the inner surface 129 of the second section 120, as shown in FIGS. 1, 3, and 4. In this embodiment, the adhesive 200 is thus positioned in the adhesive channel 150 by insertion of the cable 30 into the sealing passageway 140. The heating of the adhesive 200 and attaching of the cable 30 to the seal 100 then proceeds as in the embodiment described above.

In use, the sealed cable 10 can be inserted into a housing. The first thickness 112 of the first section 110, shown in FIG. 3, is adapted to a size of an opening of the housing; the ribs 160 resiliently engage the housing to form a seal between the seal 100 and the housing that seals the cable 30.

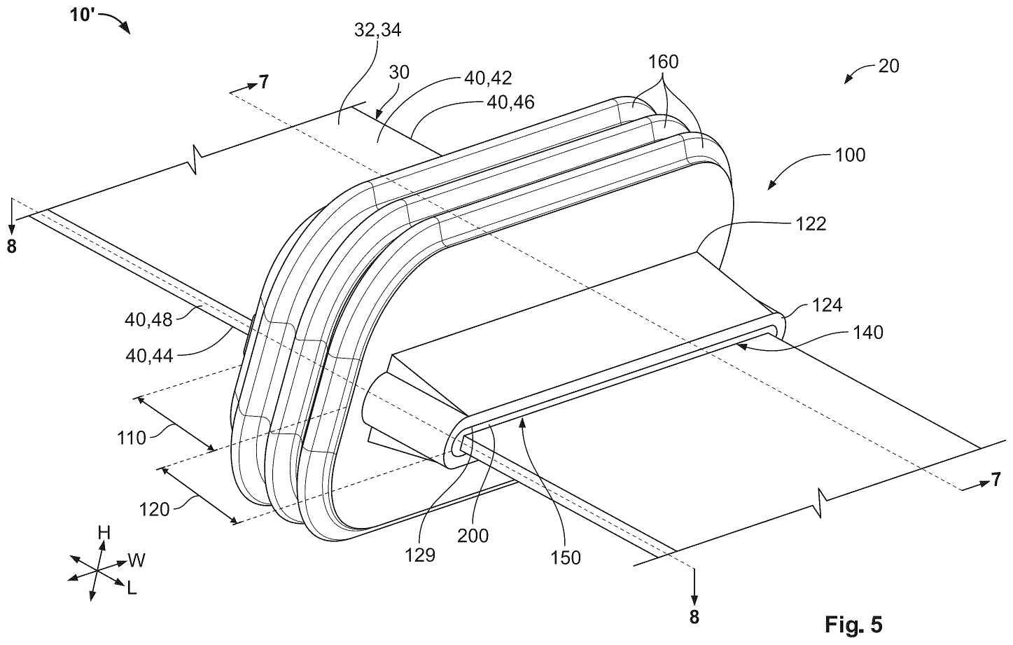

A sealed cable 10′ according to another embodiment is shown in FIGS. 5-8 and will now be described in greater detail. Like reference numbers refer to like elements with respect to the sealed cable 10 of the embodiment shown in FIGS. 1-4, and primarily the differences of the scaled cable 10′ will be described in detail herein.

In the sealed cable 10′, the seal 100 is formed from a combination of the elastomeric material 170 and a support 180 that is formed of a rigid, insulative material. The elastomeric material 170 and the support 180 define different portions of the first section 110 and the second section 120 of the seal 100.

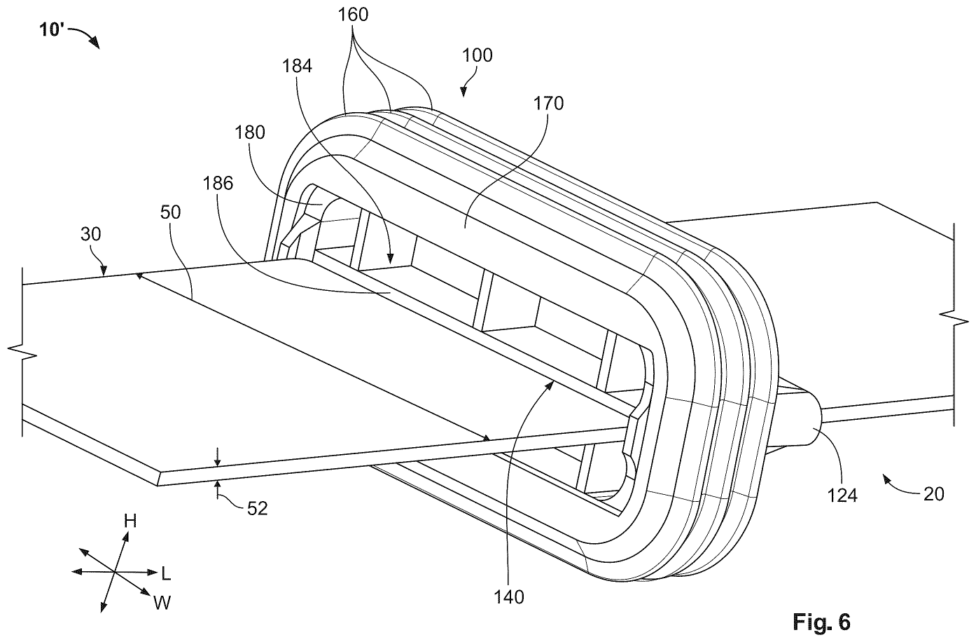

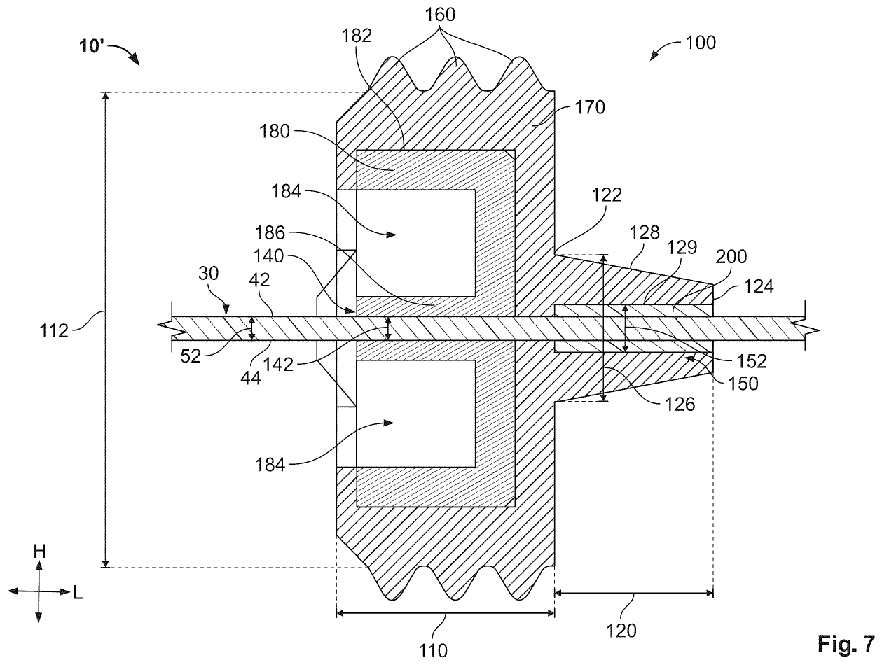

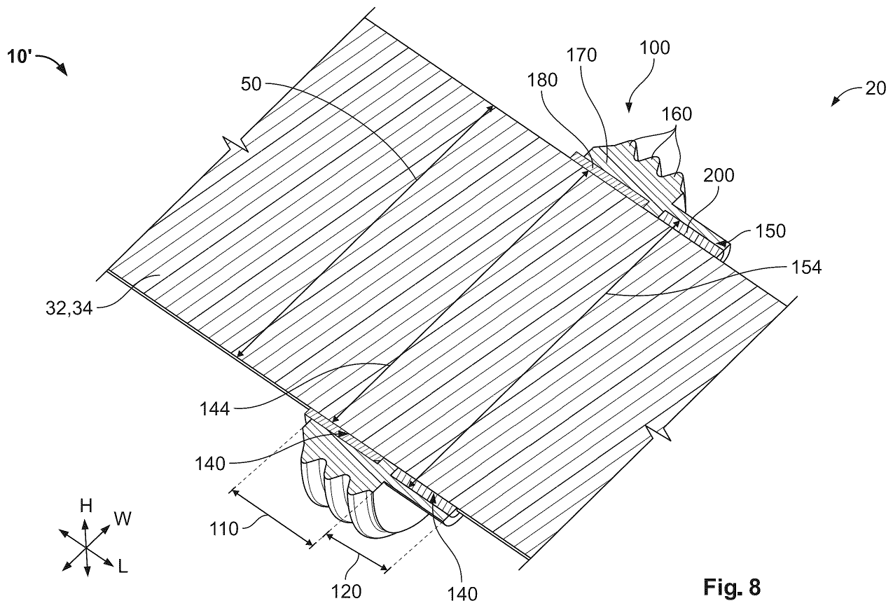

As shown in FIGS. 6-8, in the first section 110 of the seal 100, the support 180 is positioned within the elastomeric material 170. The support 180 defines an outer surface 182 and has a central section 186 separated from the outer surface 182 by a plurality of openings 184. The elastomeric material 170 extends around the support 180 in the first section 110 and the support 180 defines the sealing passageway 140 in the first section 110. The sealing passageway 140 defined by the support 180 has the same first height 142 and first width 144 as in the sealed cable 10, as shown in FIGS. 7 and 8. The support 180 holds and supports the elastomeric material 170 at a first thickness 112 that is larger than the first thickness 112 of the sealed cable 10 in the embodiment of FIGS. 1-4 in order to seal to a housing having a larger opening.

In the sealed cable 10′, as shown in FIGS. 5-8, the second section 120 is identical to the second section 120 of the embodiment of FIGS. 1-4 and is formed entirely of the elastomeric material 170.

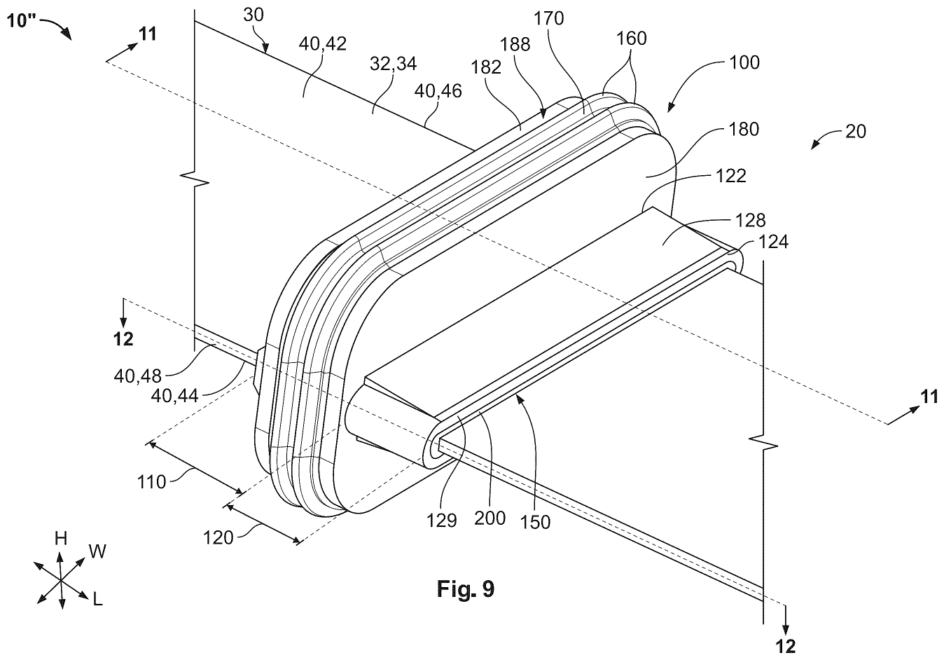

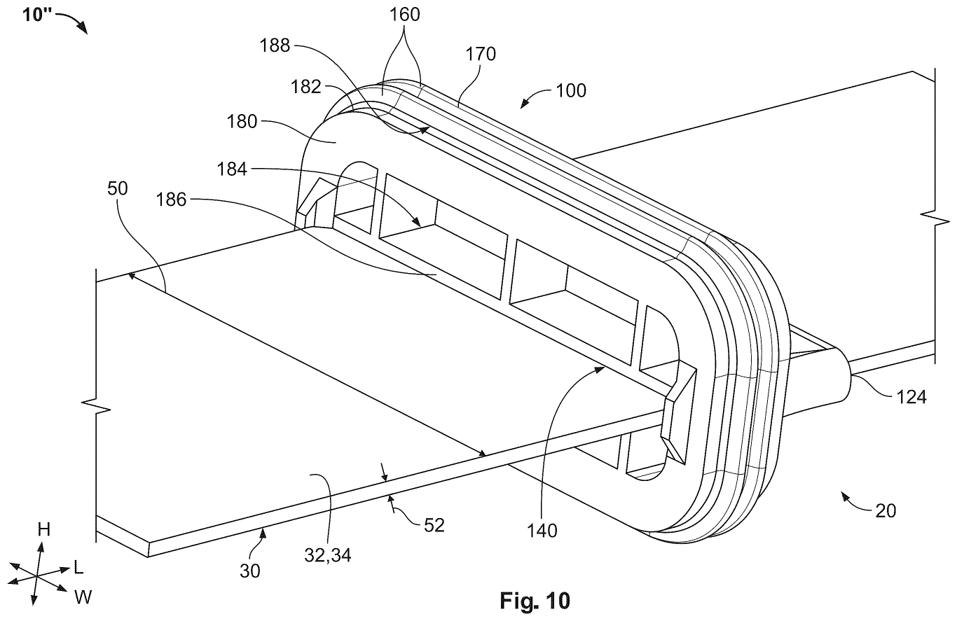

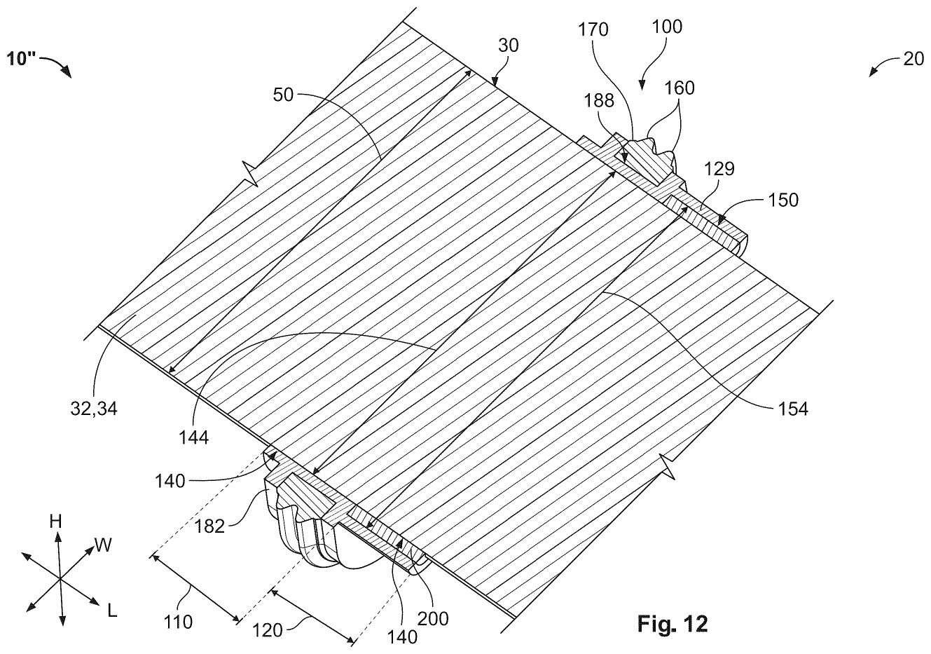

A sealed cable 10″ according to another embodiment is shown in FIGS. 9-12 and will now be described in greater detail. Like reference numbers refer to like elements with respect to the sealed cable 10 of the embodiment shown in FIGS. 1-4 and the sealed cable 10′ of the embodiment shown in FIGS. 5-8, and primarily the differences of the sealed cable 10″ will be described in detail herein.

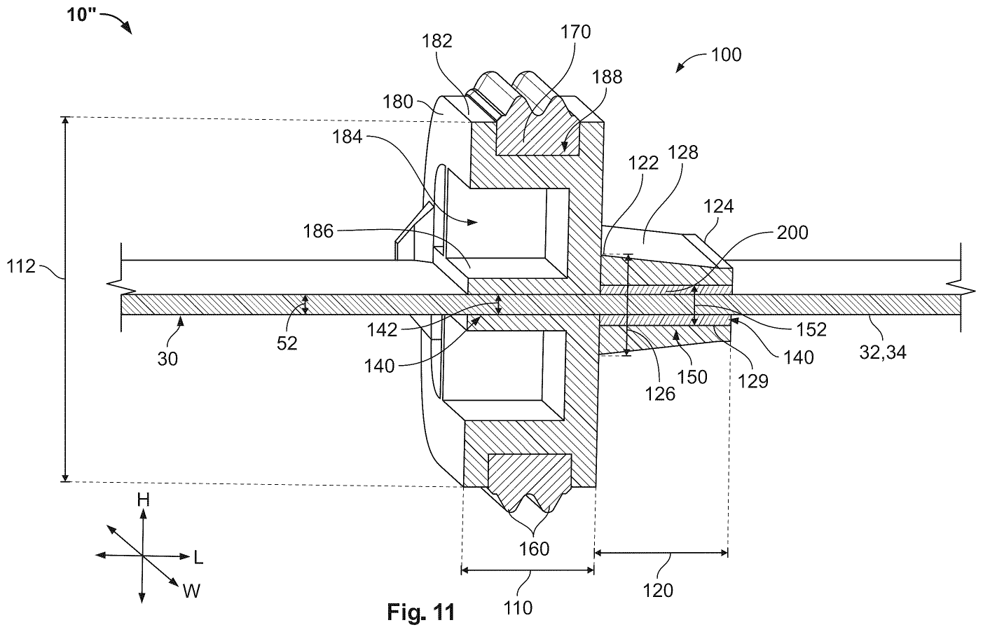

In the sealed cable 10″, the seal 100 is formed from the combination of the elastomeric material 170 and the support 180, as in the embodiment of the sealed cable 10′. In the embodiment of the sealed cable 10″ shown in FIGS. 9-12, however, the elastomeric material 170 is only positioned in the first section 110. In the first section 110, as shown in FIGS. 9 and 11, the support 180 has a seal channel 188 extending into the outer surface 182 and circumferentially around the support 180. The seal channel 188 is bordered by portions of the support 180 along the longitudinal direction L in the first section 110. The elastomeric material 170, forming the ribs 160, is positioned and secured in the seal channel 188.

As shown in FIGS. 9, 11, and 12, in the sealed cable 10″, the support 180 comprised of the rigid insulative material forms an entirety of the second section 120. In this embodiment, the support 180 defines the sealing passageway 140 in the first section 110 and defines the sealing passageway 140 and the adhesive channel 150 in the second section 120. When the adhesive 200 is heated to attach the cable 30 to the seal 100 in this embodiment, the insulative material of the support 180 in the second section 120 may also melt and form a part of the bond.

In the embodiments of the sealed cable 10, 10′, 10″ described above, the second section 120 is shown and described as extending in one direction along the longitudinal direction L from the first section 110. In other embodiments, in combination with any of the embodiments of the sealed cable 10, 10′, 10″ described above, the second section 120 may extend in the opposite direction along the longitudinal direction L from the first section 110, or the sealed cable 10, 10′, 10″ may have two second sections 120 formed as described above extending from both sides of the first section 110 and in opposite direction from the first section 110 along the longitudinal direction L.

In the sealed cables 10, 10′, 10″ according to the above embodiments, the addition of the adhesive 200 in the adhesive channel 150 forms a more reliable seal between the seal 100 and the cable 30 by attaching the seal 100 to the cable 30 through the heating and melting process, avoiding issues that can arise with lack of sealing force on a non-round cable. The adhesive 200 also protects portions of the seal 100 from damage that can arise from sharp edges of the cable 30. The embodiments of the sealed cables 10′, 10″ having the support 180 that can form the sealing passageway 140 and/or the adhesive channel 150 provide an even more robust connection between the seal 100 and the cable 30 through the adhesive 200, while maintaining the elastomeric material 170 having the ribs 160 for sealing engagement with a housing.

What is claimed is:

1. A seal assembly, comprising:
a seal including a first section and a second section extending from the first section, the seal has a sealing passageway extending through the first section and the second section along a longitudinal direction, the second section has an adhesive channel extending around the sealing passageway; and
an adhesive positioned in the adhesive channel of the second section, the adhesive is disposed on an inner surface of the seal in the second section.

2. The seal assembly of claim 1, wherein the second section tapers from a first end connected to the first section to a second end opposite the first end along the longitudinal direction.

3. The seal assembly of claim 1, wherein the seal has a plurality of ribs formed of an elastomeric material in the first section.

4. The seal assembly of claim 3, wherein the ribs circumferentially surround the seal and protrude outward from the seal in the first section.

5. The seal assembly of claim 1, wherein the seal has a first thickness in a height direction perpendicular to the longitudinal direction in the first section and the seal has a second thickness in the height direction in the second section, the first thickness is greater than the second thickness.

6. The seal assembly of claim 1, wherein the first section and the second section are monolithically formed in a single piece from an elastomeric material.

7. The seal assembly of claim 1, wherein the seal includes an elastomeric material and a support positioned within the elastomeric material.

8. The seal assembly of claim 7, wherein the support is positioned in the first section and the elastomeric material extends around the support in the first section, the support defines the sealing passageway in the first section.

9. The seal assembly of claim 8, wherein the second section is formed of the elastomeric material, the elastomeric material defines the sealing passageway and the adhesive channel in the second section.

10. The seal assembly of claim 8, wherein the elastomeric material is positioned within a seal channel extending into an outer surface of the support.

11. The seal assembly of claim 10, wherein the support forms the second section and defines the sealing passageway and the adhesive channel in the second section.

12. The seal assembly of claim 1, wherein the sealing passageway has a first height in a height direction perpendicular to the longitudinal direction and a first width in a width direction perpendicular to the longitudinal direction and the height direction, the adhesive channel has a second height in the height direction and a second width in the width direction, the second height is greater than the first height and the second width is greater than the first width.

13. The seal assembly of claim 1, wherein the adhesive is a heat-activated adhesive.

14. A sealed cable, comprising:
a seal assembly including a seal and an adhesive, the seal has a first section and a second section extending from the first section, the seal has a sealing passageway extending through the first section and the second section along a longitudinal direction, the second section has an adhesive channel extending around the sealing passageway, the adhesive is positioned in the adhesive channel of the second section, the adhesive is disposed on an inner surface of the seal in the second section; and
a cable positioned in the sealing passageway and having a body contacted by the adhesive.

15. The sealed cable of claim 14, wherein the adhesive attaches the cable to the seal.

16. The sealed cable of claim 14, wherein the sealing passageway has a first height in a height direction perpendicular to the longitudinal direction and a first width in a width direction perpendicular to the longitudinal direction and the height direction, the first height is approximately equal to a cable height of the cable in the height direction and the first width is approximately equal to a cable width of the cable in the width direction.

17. A method of sealing a cable, comprising:
providing a seal having a first section and a second section extending from the first section, the seal has a sealing passageway extending through the first section and the second section along a longitudinal direction, the second section has an adhesive channel extending around the sealing passageway;
positioning an adhesive in the adhesive channel of the second section; and
inserting a cable into the sealing passageway, a body of the cable is in contact with the adhesive.

18. The method of claim 17, further comprising activating the adhesive with heat to reflow the adhesive and bond the cable to the seal.

19. The method of claim 18, wherein a portion of the second section and/or a portion of the body of the cable melts and forms a part of the bond with the application of heat.

20. The method of claim 17, wherein the adhesive is positioned in the adhesive channel or on the cable before the cable is inserted into the sealing passageway.
